(19) United States
(12) Patent Application Publication
(10) Pub. No.: US 2021/0266633 A1
(43) Pub. Date: Aug. 26, 2021

(54) REAL-TIME VOICE INFORMATION INTERACTIVE METHOD AND APPARATUS, ELECTRONIC DEVICE AND STORAGE MEDIUM

(71) Applicant: BEIJING DAJIA INTERNET INFORMATION TECHNOLOGY CO., LTD., Beijing (CN)

(72) Inventor: Qi ZHANG, Beijing (CN)

(73) Assignee: BEIJING DAJIA INTERNET INFORMATION TECHNOLOGY CO., LTD., Beijing (CN)

(21) Appl. No.: 17/257,563

(22) PCT Filed: Sep. 4, 2019
(86) PCT No.: PCT/CN2019/104421

§ 371 Date: Jan. 1, 2021

(30) Foreign Application Priority Data
Sep. 4, 2018 (CN) 201811027779.0

(51) Int. Cl. H04N 21/439; G10L 15/22; H04N 21/422; H04N 21/2187; H04N 21/4788

(52) U.S. Cl. CPC H04N 21/4396; G10L 15/22; H04N 21/4788; H04N 21/2187; H04N 21/42203

(57) ABSTRACT

Provided in the embodiments of the present application are a real-time voice information interactive method and apparatus, an electronic device and a storage medium. The interactive method and apparatus specifically respond to a user's recording request, record and convert a user's voice, and obtain at least one piece of voice data, wherein at least one piece of voice data is stored in a sending queue in the form of a queue; send the voice data in the sending queue to a server of a real-time information interaction system in turn; display the voice data in the sending queue locally in a list, and display the sending state of the voice data. Through the above operations, a user can upload voice data in a voice manner, and can also make the voice data fully function as text in the real-time information interactive system, thereby greatly facilitating users who input text slowly or are not able to input text, and improving the user experience.

### CROSS REFERENCES TO RELATED APPLICATIONS

The present application is the 371 application of PCT Application No. PCT/CN2019/104421 filed Sep. 4, 2019, which claims the priority of Chinese Patent Application No. 201811027779.0, entitled “Real-time voice information interactive method and apparatus, an electronic device and a storage medium”, filed with the Chinese Patent Office on Sep. 4, 2018, which are hereby incorporated herein by reference in their entireties.

### TECHNICAL FIELD

The application relates to the field of Internet technologies, and in particular to real-time voice information interactive methods, apparatuses, electronic devices, and storage media.

### BACKGROUND

In some real-time information interactive systems based on the Internet, some of them exchange information in a one-to-many manner. For example, in a webcast system, in most cases, there is only one host in a live stream room, but there will be many audiences. Therefore, the webcast realizes an interactive communication scene with one-to-many communication as a main mode and host's video and audio expression as a center, and needs to ensure an equal relationship between the audiences. In this mode, the audience can only express through text.

However, an inventor realizes that audience's levels are uneven. Some people's text input speed is slow, or even unable to input text. This prevents many people from expressing their opinions effectively, which makes the audience's experience worse, and is not conducive to expanding audience coverage of the webcast.

### SUMMARY

The application provides a real-time voice information interactive method and apparatus, an electronic device and a storage medium.

Implementations of the application provide a real-time voice information interactive method, applied to an electronic device, and the interactive method includes: in response to a recording request, recording and converting an input voice to obtain at least one piece of voice data, wherein the at least one piece of voice data is stored in a sending queue in a queue form; sending the voice data in the sending queue to a server that is in a long connection with the electronic device in turn, so that the server pushes the received voice data to a first electronic device corresponding to an electronic device recording the voice data, and so that the first electronic device displays the voice data in a list form to make a user of the first electronic device select voice data in the list to play; and displaying the voice data in the sending queue locally in the list form, and displaying a sending state of the voice data.

The technical solutions provided by the implementations of the application may include following beneficial effects: the user can upload the voice data in a voice manner, and can also make the voice data fully function as text in the real-time information interactive system, which greatly facilitates users who input text slowly or are not able to input text, and improving the user experience.

### BRIEF DESCRIPTION OF THE DRAWINGS

The accompanying drawings, which are incorporated in the specification and constitute a part of the specification, show example implementations of the application. The drawings along with the specification explain the principles of the application.

FIG. 1 is a flowchart showing a real-time voice information interactive method according to an example implementation;

FIG. 2 is a flowchart showing another real-time voice information interactive method according to an example implementation;

FIG. 3 is a structural block diagram showing a real-time voice information interactive apparatus according to an example implementation;

FIG. 4 is a structural block diagram showing another real-time voice information interactive apparatus according to an example implementation;

FIG. 5 is a flowchart showing yet another real-time voice information interactive method according to an example implementation;

FIG. 6 is a structural block diagram showing yet another real-time voice information interactive apparatus according to an example implementation;

FIG. 7 is a flowchart showing yet another real-time voice information interactive method according to an example implementation;

FIG. 8 is a flowchart showing yet another real-time voice information interactive method according to an example implementation;

FIG. 9 is a structural block diagram showing yet another real-time voice information interactive apparatus according to an example implementation;

FIG. 10 is a structural block diagram showing yet another real-time voice information interactive apparatus according to an example implementation;

FIG. 11 is a structural block diagram showing a server according to an example implementation;

FIG. 12 is a structural block diagram showing an electronic device according to an example implementation; and

FIG. 13 is a structural block diagram showing another electronic device according to an example implementation.

### DETAILED DESCRIPTION

Example implementations will be described in detail herein, examples of which are illustrated in the accompanying drawings. The implementations described in the following example implementations are merely examples of apparatuses and methods consistent with aspects of the application as detailed in the appended claims.

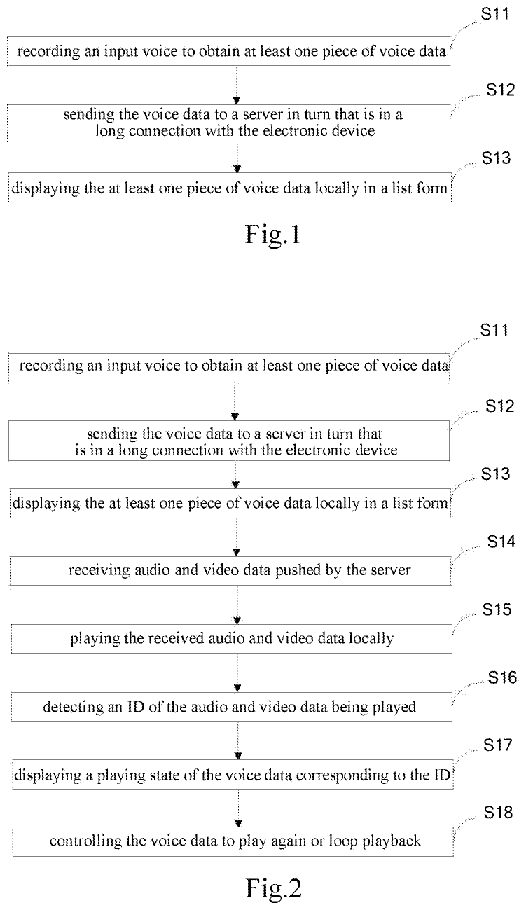

FIG. 1 is a flowchart showing a real-time voice information interactive method according to an example implementation.

As shown in FIG. 1, this specific interactive method is applied to an electronic device. In some implementations, the interactive method in this specific implementation is applied to an audience side of a webcast system. The interactive method includes the following operations.

In operation S11, obtaining at least one piece of voice data by recording an input voice. In some implementations, an electronic device may record the input voice and generate at least one piece of voice data.

In response to a user at the audience side sending a recording request through the audience terminal, the input voice is recorded and converted to obtain the at least one piece of voice data, that is, a digitized voice signal. In some implementations, a corresponding voice signal is obtained from a recording device connected to the audience terminal and converted to obtain the voice data. Specific implementation operations are as follows.

First, in response to the user sending the recording request, a voice signal sent by the user is obtained, and the voice signal is converted into a piece of audio data every preset duration. That is, the audio data is converted from the voice signal of the preset duration. In practice, the preset duration can be selected as 20 milliseconds.

Then, the multiple pieces of audio data generated for each recording are collected and synthesized into an independent voice data file. Generally speaking, the duration of the voice data coverage is duration of the current recording request. For a specific audience terminal, it may be the duration in which the user at the audience side presses a recording button.

In addition, in response to the user sending the recording request, the playing volume of the audio and video played by the audience terminal is reduced until it is reduced to 0, that is, the audio and video are controlled to be muted, which can prevent noise from interfering with the recording and obtain purer voice data.

In operation S12, sending the voice data to a server that is long connected with the electronic device sequentially. In some implementations, an electronic device may send the voice data to a server that is long connected with the electronic device sequentially.

Since this implementation can be applied to the webcast system, after obtaining the voice data, the audience terminal sequentially sends the voice data to the server through the long connection with the server, so that the server stores the voice data. After receiving the voice data, the server pushes the voice data to a first electronic device corresponding to the electronic device that records the voice data. Here, since the voice data is recorded by the audience terminal of the webcast system, the first electronic device corresponding to the audience terminal is a host terminal of the webcast system.

After receiving the voice data, the server sends the voice data to the first electronic device, that is, to the host terminal, and causes the host terminal to display the multiple pieces of voice data in a list form, and the user at the host side can select and play the voice data. The so-called “select and play” refers to selecting corresponding voice data from the list to play.

In operation S13, displaying at least one piece of voice data locally in the list form. In some implementations, an electronic device may display at least one piece of voice data locally in the list form.

In practical applications, the recorded voice data is often not limited to one piece. Therefore, in order to facilitate the user to view, the multiple pieces of voice data are displayed in the list form. A specific display mode may be to display multiple icons only in the list form, and each icon corresponds to one piece of voice data. In addition to displaying the multiple pieces of voice data in a list, a state of the corresponding voice data is displayed at a preset position of each piece of voice data. For example, in response to the voice data being uploaded to the server, the state of the voice data is displayed as being uploaded, and if the uploading is completed, the state of the voice data is displayed as the sending completed.

It can be seen from the above technical solutions that the implementations of the application provide a real-time voice information interactive method, which is applied to a real-time information interactive system, and the interactive method is: in response to the recording request of the user, recording and converting the input voice to obtain at least one piece of voice data, and the at least one piece of voice data is stored in a sending queue in a queue form; sequentially sending the voice data in the sending queue to the server of the real-time information interactive system; displaying the voice data in the sending queue locally in the list form, and displaying a sending state of the voice data. Through the above operations, the user can upload the voice data in a voice manner, and can also make the voice data fully function as text in the real-time information interactive system, which greatly facilitates users who input text slowly or are not able to input text, and improving the user experience.

In addition, in this specific implementation manner, the following operations may also be included:

deleting the corresponding voice data according to a user's deleting request.

In practical applications, the user may sometimes find that the sent voice data is not satisfactory and needs to be deleted. Therefore, the purpose of this operation is to, when the user needs the deleting and sends the deleting request, delete the voice data corresponding to the deleting request in response to the deleting request, which prevents unsatisfactory voice data from being pushed to other users.

If the corresponding voice data has been uploaded to the server, in this case, a deletion control instruction is sent to the server according to the deleting request to control the server to delete the corresponding voice data.

FIG. 2 is a flowchart showing another real-time voice information interactive method according to an implementation.

As shown in FIG. 2, this specific interactive method is applied to the real-time information interactive system. The real-time information interactive system can be the webcast system in practical applications. Therefore, the interactive method in this specific implementation is applied to the audience side of the webcast system, and the interactive method includes the following operations.

In operation S11, obtaining at least one piece of voice data by recording an input voice. In some implementations, an electronic device may record the input voice and generate at least one piece of voice data.

The function of this operation is basically the same as that of the previous specific implementation, and will not be repeated here.

In operation S12, sending the voice data to a server that is long connected with the electronic device sequentially. In some implementations, an electronic device may send the voice data to a server that is long connected with the electronic device sequentially.

The function of this operation is basically the same as that of the previous specific implementation, and will not be repeated here.

In operation S13, displaying at least one piece of voice data locally in the list form. In some implementations, an electronic device may display at least one piece of voice data locally in the list form.

The function of this operation is basically the same as that of the previous specific implementation. The difference is that the voice data displayed in the list form includes not only the voice data recorded locally, but also the voice data pushed by the server which is from a second electronic device which is at an equal position as the device used for recording the voice data locally. For the webcast system, the list includes not only the voice data recorded by the local audience terminal, but also the voice data recorded by other audience terminals.

The equal position here is not completely equal, but actually refers to the equal state of the basic operation methods, with unequal contents of priority methods. For example, for the user with higher activity, the user has higher priority.

In operation S14, receiving audio and video data pushed by the server. In some implementations, an electronic device may receive audio and video data pushed by the server.

In addition to uploading locally recorded voice data to the server locally, the audio and video data sent by the server is also received, the audio and video data pushed by the server is also received. The audio and video data includes the audio and video data recorded by the first electronic device corresponding to the electronic device recording the local voice data, and voice data recorded by the second electronic device that has an equal position with the local electronic device.

For the webcast system, the audio and video data comes from the host side and other audience sides of the system. The audio and video data from the host side is the audio data and video data recorded by the user at the host side, the voice data from other audience sides is part or all of the voice data selected by the user at the host side for play after the voice data is uploaded to the server.

In operation S15, playing the received audio and video data locally. In some implementations, an electronic device may play the received audio and video data locally.

For the webcast system in the practical applications, the audio and video data pushed by the server is played at the audience side. The audio and video data includes the audio data and video data recorded by the host terminal, and also includes the voice data sent by other audience terminals.

In operation S16, detecting an ID of the audio and video data being played. In some implementations, an electronic device may detect an ID of the audio and video data being played.

In some implementations, it is to detect the ID of the voice data that is played simultaneously in the audio and video data. The ID may be matched with the multiple pieces of voice data displayed in the list, i.e., they are from the same electronic device.

In operation S17, displaying a playing state of the voice data corresponding to the ID. In some implementations, an electronic device may display a playing state of the voice data corresponding to the ID.

That is, if the voice data displayed in the list matches the ID of the playing audio and video data, the voice data is displayed in the list as being played, so that the user can determine that the voice data is being played in the playing audio and video data at the same time, so that corresponding operations can be performed, such as playing again or looping.

In operation S18, controlling the voice data to be played again or looped. In some implementations, an electronic device may control the voice data to be played again or looped.

When the user needs to play the voice data corresponding to the ID again, the user can input the corresponding loop playback instruction. The loop playback instruction is used for controlling the voice data to be played again, and also to be looped in an unlimited or limited number of times, so that the user can know exactly what the corresponding voice data carries.

Through the above operations, the user can upload the voice data in a voice manner, and can also make the voice data fully function as text in the real-time information interactive system, which greatly facilitates users who input text slowly or are not able to input text, and improving the user experience, and also making the user obtain more advanced experience.

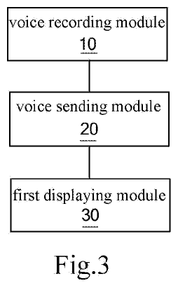

FIG. 3 is a structural block diagram showing a real-time voice information interactive apparatus according to an example implementation.

As shown in FIG. 3, the specific interactive apparatus is applied in the electronic device. In some implementations, the interactive apparatus in this specific implementation is applied to the audience side of the webcast system. The interactive apparatus includes a voice recording module 10, a voice sending module 20 and a first displaying module 30.

The voice recording module 10 is configured to record the input voice to obtain at least one piece of voice data.

When a user in the audience side sends a recording request through the audience terminal, the input voice is recorded and converted to obtain the at least one piece of voice data, that is, a digitized voice signal. In some implementations, a corresponding voice signal is obtained from a recording device connected to the audience terminal and converted to obtain the voice data. The module includes a recording control unit and a data collecting unit.

The recording control unit is configured to, in response to the user sending the recording request, obtain a voice signal sent by the user, and convert the voice signal into a piece of audio data every preset duration. That is, the audio data is converted from the voice signal of the preset duration. In practice, the preset duration can be selected as 20 milliseconds.

The data collecting unit is configured to collect multiple pieces of audio data generated by each recording and synthesize them into an independent voice data file. Generally speaking, the duration of the voice data coverage is duration of the current recording request. For a specific audience terminal, it may be the duration in which the user at the audience side presses a recording button.

In addition, the module also includes a mute control unit, which is configured to reduce the playing volume of the audio and video played by the audience terminal to 0 in response to the user sends the recording request, that is, the audio and video are controlled to be muted, which can prevent noise from interfering with the recording and obtain purer voice data.

The voice sending module 20 is configured to sequentially send the voice data to a server that is connected to an electronic device.

Since this implementation can be applied to the webcast system, after obtaining the voice data, the audience terminal sequentially sends the voice data to the server through the long connection with the server, so that the server stores the voice data. After receiving the voice data, the server pushes the voice data to a first electronic device corresponding to the electronic device that records the voice data. Here, since the voice data is recorded by the audience terminal of the webcast system, the first electronic device corresponding to the audience terminal is a host terminal of the webcast system.

After receiving the voice data, the server sends the voice data to the first electronic device, that is, to the host terminal, and causes the host terminal to display the multiple pieces of voice data in a list form, and the user at the host side can select and play the voice data. The so-called “select and play” refers to selecting corresponding voice data from the list to play.

The first displaying module 30 is configured to display the at least one piece of voice data locally in a list form.

In practical applications, the recorded voice data is often not limited to one piece. Therefore, in order to facilitate the user to view, the multiple pieces of voice data are displayed in the list form. A specific display mode may be to display multiple icons only in the list form, and each icon corresponds to one piece of voice data. In addition to displaying the multiple pieces of voice data in a list, a state of the corresponding voice data is displayed at a preset position of each piece of voice data. For example, in response to the voice data being uploaded to the server, the state of the voice data is displayed as being uploaded, and if the uploading is completed, the state of the voice data is displayed as the sending completed.

It can be seen from the above technical solutions that the implementation of the application provides the real-time voice information interactive apparatus, which is applied to the real-time information interactive system, and the interactive apparatus is: in response to the recording request of the user, recording and converting the input voice to obtain at least one piece of voice data, and the at least one piece of voice data is stored in a sending queue in a queue form; sequentially sending the voice data in the sending queue to the server of the real-time information interactive system; displaying the voice data in the sending queue locally in the list form, and displaying a sending state of the voice data. Through the above operations, the user can upload the voice data in a voice manner, and can also make the voice data fully function as text in the real-time information interactive system, which greatly facilitates users who input text slowly or are not able to input text, and improving the user experience.

In addition, in this specific implementation manner, a first deleting module (not shown) may also be included.

The first deleting module is configured to delete the corresponding voice data according to a user's deleting request.

In practical applications, the user may sometimes find that the sent voice data is not satisfactory and needs to be deleted. Therefore, the purpose of this operation is to, when the user needs the deleting and sends the deleting request, delete the voice data corresponding to the request in response to the deleting request, which prevents unsatisfactory voice data from being pushed to other users.

If the corresponding voice data has been uploaded to the server, in this case, a deletion control instruction is sent to the server according to the deleting request to control the server to delete the corresponding voice data.

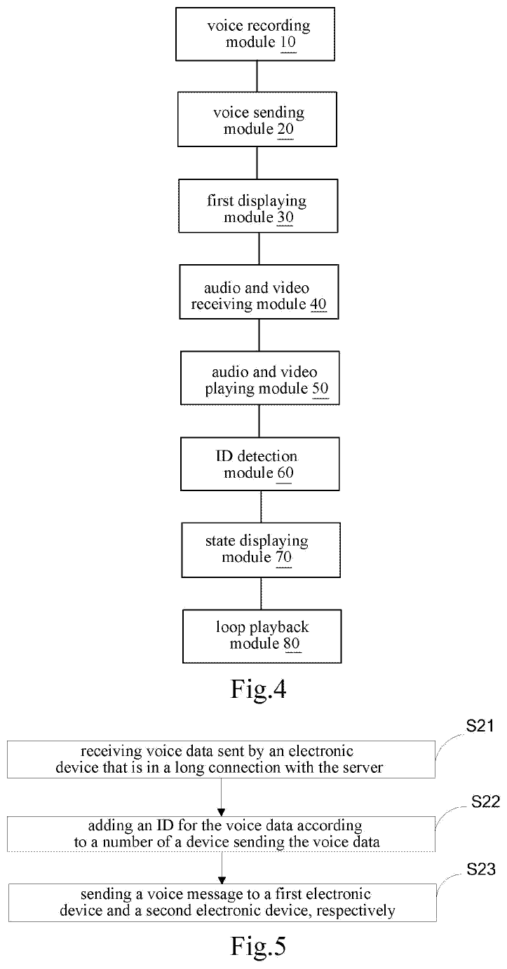

FIG. 4 is a structural block diagram showing another real-time voice information interactive apparatus according to an example implementation.

As shown in FIG. 4, the specific interactive apparatus is applied to the electronic device. In some implementations, the interactive apparatus in this specific implementation is applied to the audience side of the webcast system. Compared with the previous specific implementation, the interactive apparatus is additionally provided with an audio and video receiving module 40, an audio and video playing module 50, an ID detection module 60, a state displaying module 70 and a loop playback module 80.

The first displaying module is also configured to display the at least one piece of voice data locally in the list form. However, there is a certain difference. The difference is that the voice data displayed in the list form includes not only the voice data recorded locally, but also the voice data pushed by the server which is from a second electronic device which is at an equal position as the electronic device used for recording the voice data locally. For the webcast system, the list includes not only the voice data recorded by the local audience terminal, but also the voice data recorded by other audience terminals.

The audio and video receiving module 40 is configured to receive the audio and video data pushed by the server.

In addition to uploading locally recorded voice data to the server locally, the audio and video data sent by the server is also received, the audio and video data pushed by the server is also received. The audio and video data includes the audio and video data recorded by the first electronic device corresponding to the electronic device recording the local voice data, and voice data recorded by the second electronic device that has an equal position with the local electronic device.

For the webcast system, the audio and video data comes from the host side and other audience sides of the system. The audio and video data from the host side is the audio data and video data recorded by the user at the host side, the voice data from other audience sides is part or all of the voice data selected by the user at the host side for play after the voice data is uploaded to the server.

The audio and video playing module 50 is configured to play the received audio and video data locally.

For the webcast system in the practical applications, the audio and video data pushed by the server is played at the audience side. The audio and video data includes the audio data and video data recorded by the host terminal, and also includes the voice data sent by other audience terminals.

The ID detection module 60 is configured to detect an ID of the audio and video data being played.

In some implementations, it is to detect the ID of the voice data that is played simultaneously in the audio and video data. The ID may be matched with the multiple pieces of voice data displayed in the list, i.e., they are from the same electronic device.

The state displaying module 70 is configured to display a playing state of the voice data corresponding to the ID.

That is, if the voice data displayed in the list matches the ID of the playing audio and video data, the voice data is displayed in the list as being played, so that the user can determine that the voice data is being played in the playing audio and video data at the same time, so that corresponding operations can be performed, such as playing again or looping.

The loop playback module 80 is configured to control the voice data to be played again or looped.

When the user needs to play the voice data corresponding to the ID again, the user can input the corresponding loop playback instruction. The loop playback instruction is used for controlling the voice data to be played again, and also to be looped in an unlimited or limited number of times, so that the user can know exactly what the corresponding voice data carries.

Through the above operations, the user can upload the voice data in a voice manner, and can also make the voice data fully function as text in the real-time information interactive system, which greatly facilitates users who input text slowly or are not able to input text, and improving the user experience, and also making the user obtain more advanced experience.

FIG. 5 is a flowchart showing another real-time voice information interactive method according to an example implementation.

As shown in FIG. 5, the interactive method provided in this specific implementation is applied to a server of the real-time information interactive system. The webcast system is taken as an example, the server is respectively connected to the host terminal and multiple audience terminals of the webcast system. The interactive method includes following operations.

In operation S21, receiving voice data sent by an electronic device that is long connected with the server. In some implementations, a server may receive voice data sent by an electronic device that is long connected with the server.

For the webcast system, the electronic device that is in a long connection with the server is the audience terminal. After the audience terminal records the voice data and uploads this voice data, the voice data is received in a queue form.

In operation S22, adding an ID to the voice data according to a number of the device sending the voice data. In some implementations, a server may add an ID to the voice data according to a number of the device sending the voice data.

In some implementations, after each piece of the voice data is received, a device number of the hardware device sending the voice data is detected, and an ID is edited according to the detected device number, and the ID is added to the corresponding voice data.

In operation S23, sending a voice message to the first electronic device and the second electronic device respectively. In some implementations, a server may send a voice message to the first electronic device and the second electronic device respectively.

The first electronic device here corresponds to the electronic device that sends the corresponding voice data, and the second electronic device has an equal position with the electronic device that sends the corresponding voice data. For the webcast system, the audience terminal is the one that sends the voice data, the first electronic device is the host terminal, and the second electronic device is the other audience terminal.

The voice message sent to the first electronic device also includes sender information, duration, and the ID of the voice data, so that the user of the first electronic device, that is, the user at the host side, can select the voice message to select the voice data corresponding to the voice message for playing. The voice information sent to the second electronic device is the voice message corresponding to the voice data selected to be played by the user at the host side.

Through the above operations, it is possible to make other electronic devices connected to the server display the stored voice data, so that the user can choose to play and the played voice data is pushed to other electronic devices.

In addition, in this specific implementation manner, the following operation is further included:

in response to a deleting request sent by the electronic device that sends the voice data, selectively deleting the voice data sent by the electronic device so as to avoid widespread of the voice data that the user is not satisfied.

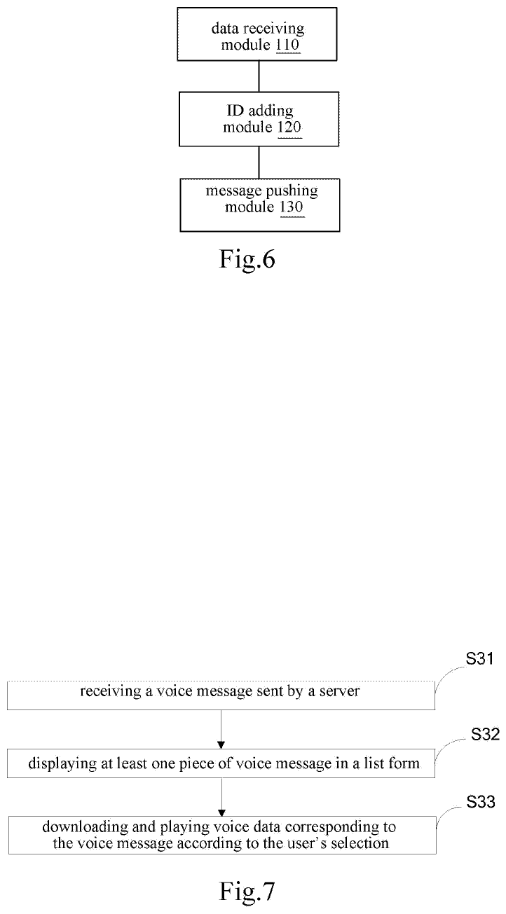

FIG. 6 is a structural block diagram showing another real-time voice information interactive apparatus according to an implementation.

As shown in FIG. 6, the interactive apparatus provided in this specific implementation is applied to a server of the real-time information interactive system. The webcast system is taken as an example, the server is respectively connected to the host terminal and multiple audience terminals of the webcast system. The interactive apparatus includes a data receiving module 110, an ID adding module 120, and a message pushing module 130.

The data receiving module 110 is configured to receive voice data sent by an electronic device that is in a long connection with the server.

For the webcast system, the electronic device that is in a long connection with the server is the audience terminal. After the audience terminal records the voice data and uploads this voice data, the voice data is received in a queue form.

The ID adding module 120 is configured to add an ID to the voice data according to a number of the device sending the voice data.

In some implementations, after each piece of the voice data is received, a device number of the hardware device sending the voice data is detected, and an ID is edited according to the detected device number, and the ID is added to the corresponding voice data.

The message pushing module 130 is configured to send a voice messages to the first electronic device and the second electronic device respectively.

The first electronic device here corresponds to the electronic device that sends the corresponding voice data, and the second electronic device has an equal position with the electronic device that sends the corresponding voice data. For the webcast system, the audience terminal is the one that sends the voice data, the first electronic device is the host terminal, and the second electronic device is the other audience terminal.

The voice message sent to the first electronic device also includes sender information, duration, and the ID of the voice data, so that the user of the first electronic device, that is, the user at the host side, can select the voice message to select the voice data corresponding to the voice message for playing. The voice information sent to the second electronic device is the voice message corresponding to the voice data selected to be played by the user at the host side.

Through the above operations, it is possible to make other electronic devices connected to the server display the stored voice data, so that the user can choose to play and the played voice data is pushed to other electronic devices.

In addition, in this specific implementation, a second deleting module (not shown) is also included.

The second deleting module is configured to, in response to a deleting request sent by the electronic device that sends the voice data, selectively delete the voice data sent by the electronic device so as to avoid widespread of the voice data that the user is not satisfied.

FIG. 7 is a flowchart showing yet another real-time voice interactive method according to an example implementation.

As shown in FIG. 7, the interactive method provided in this specific implementation is applied to the electronic device. For the webcast system, the interactive method is applied to the host terminal of the webcast system that is in a long connection with the server. The interactive method includes the following operations.

In operation S31, receiving a voice message sent by the server. In some implementations, an electronic device may receive a voice message sent by the server.

In some implementations, the voice message pushed by the server is received through the long connection with the server.

In operation S32, displaying at least one piece of voice message in the list form. In some implementations, an electronic device may display at least one piece of voice message in the list form.

After the voice message is received, the at least one piece of voice message is displayed in the list form on the display interface for the user to choose to play. For the webcast system in the practical applications, the multiple voice messages are displayed in a list for the user at the host side to choose to play the voice data corresponding to the corresponding voice message.

In operation S33, downloading and playing the voice data corresponding to the voice message according to the user's selection. In some implementations, an electronic device may download and play the voice data corresponding to the voice message according to the user's selection.

In response to the user needs to play the corresponding voice message, the voice data corresponding to the voice message can be downloaded by clicking the corresponding voice message, and the voice data can be played in response to the download is completed or while the download is ongoing, that is, the corresponding selection to play is completed.

Through the above operations, for the webcast system, the user at the host side can select and play the uploaded voice data, which increases the host's control over the playing content and improves the flexibility of the live broadcast content.

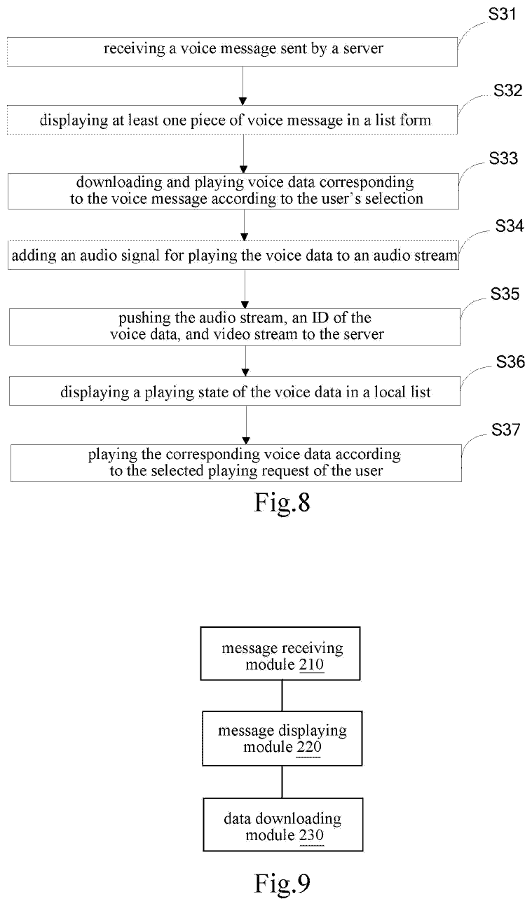

In addition, as shown in FIG. 8, the specific implementation further includes the following operations.

In operation S34, adding an audio signal for playing the voice data to the audio stream. In some implementations, an electronic device may add an audio signal for playing the voice data to the audio stream.

The audio stream here refers to audio data generated by any audio data played by the local electronic device. For the webcast system, the audio stream refers to the locally recorded audio data played by the host terminal and the voice data selected to be played, and the voice data comes from the corresponding audience terminal.

In operation S35, pushing the audio stream, the ID of the voice data and the video stream to the server. In some implementations, an electronic device may push the audio stream, the ID of the voice data and the video stream to the server.

After the audio stream is obtained, it is pushed to the server. The pushed content also includes the locally recorded video stream and the ID of the voice data selected to be played.

In operation S36, displaying the playing state of the voice data in the local list. In some implementations, an electronic device may display the playing state of the voice data in the local list.

At least one voice message is displayed in the local list, and while the corresponding voice data is played, the playing state of the voice message corresponding to the voice data is displayed. For example, a prompt that a certain voice message is being played is displayed, so that the user can know which voice data corresponding to the piece of voice message is being played.

In operation S37, playing the corresponding voice data according to the selected playing request of the user. In some implementations, an electronic device may play the corresponding voice data according to the selected playing request of the user.

In response to the user wants to re-listen or listen carefully to the played voice data, he/she can input the selected playing request by operating the prompted voice message to select the corresponding voice message, so that the voice data corresponding to the selected voice message can be played repeatedly.

FIG. 9 is a structural block diagram showing yet another real-time voice interactive apparatus according to an example implementation.

As shown in FIG. 9, the interactive apparatus provided in this implementation is applied to the electronic device. For the webcast system, the interactive apparatus is applied to the host terminal of the webcast system that is in a long connection with the server, and the interactive apparatus includes a message receiving module 210, a message displaying module 220 and a data downloading module 230.

The message receiving module 210 is configured to receive the voice message sent by the server.

In some implementations, the voice message pushed by the server is received through the long connection with the server.

The message displaying module 220 is configured to display at least one piece of voice message in the list form.

After the voice message is received, the at least one piece of voice message is displayed in the list form on the display interface for the user to choose to play. For the webcast system in the practical applications, the multiple voice messages are displayed in a list for the user at the host side to choose to play the voice data corresponding to the corresponding voice message.

The data downloading module 230 is configured to download and play the voice data corresponding to the voice message according to the user's selection.

In response to the user needs to play the corresponding voice message, the voice data corresponding to the voice message can be downloaded by clicking the corresponding voice message, and the voice data can be played in response to the download is completed or while the download is ongoing, that is, the corresponding selection to play is completed.

Through the above operations, for the webcast system, the user at the host side can select and play the uploaded voice data, which increases the host's control over the playing content and improves the flexibility of the live broadcast content.

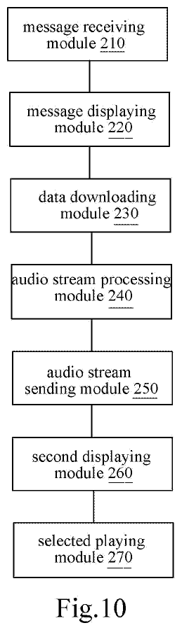

In addition, as shown in FIG. 10, this specific implementation further includes an audio stream processing module 240, an audio stream sending module 250, a second displaying module 260, and a selected playing module 270.

The audio stream processing module 240 is configured to add an audio signal for playing the voice data to the audio stream.

The audio stream here refers to audio data generated by any audio data played by the local electronic device. For the webcast system, the audio stream refers to the locally recorded audio data played by the host terminal and the voice data selected to be played, and the voice data comes from the corresponding audience terminal.

The audio stream sending module is configured to push the audio stream, the ID of the voice data, and the video stream to the server.

After the audio stream is obtained, it is pushed to the server. The pushed content also includes the locally recorded video stream and the ID of the voice data selected to be played.

The second displaying module is configured to display the playing state of the voice data in the local list.

At least one voice message is displayed in the local list, and while the corresponding voice data is played, the playing state of the voice message corresponding to the voice data is displayed. For example, a prompt that a certain voice message is being played is displayed, so that the user can know which voice data corresponding to the piece of voice message is being played.

The selected playing module is configured to play the corresponding voice data according to the selected playing request of the user.

In response to the user wants to re-listen or listen carefully to the played voice data, he/she can input the selected playing request by operating the prompted voice message to select the corresponding voice message, so that the voice data corresponding to the selected voice message can be played repeatedly.

The application also provides a computer program, which is configured to perform the operations shown in FIG. 1, FIG. 2, FIG. 5, FIG. 7 or FIG. 8.

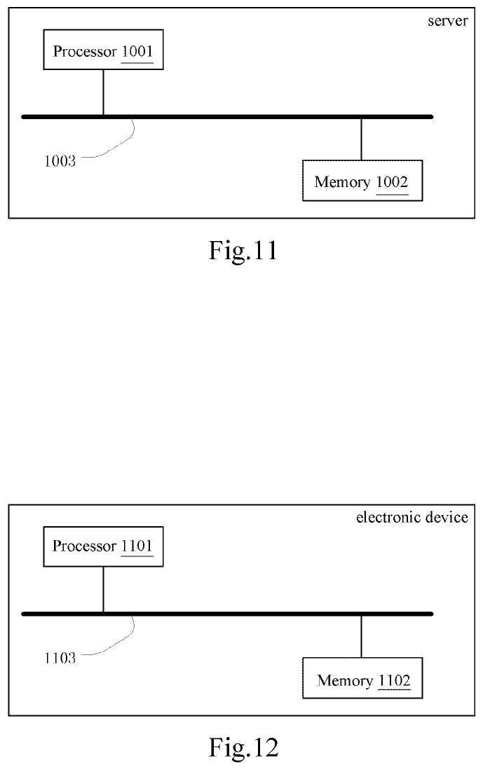

FIG. 11 is a structural block diagram showing a server according to an example implementation.

As shown in FIG. 11, the server is provided with at least one processor 1001 and also includes a memory 1002, and they are connected through a data bus1003.

The memory is configured to store a computer program or instruction, and the processor is configured to obtain and execute the computer program or instruction, so that the electronic device performs the operation shown in FIG. 5.

FIG. 12 is a structural block diagram showing an electronic device according to an example implementation.

As shown in FIG. 12, the electronic device is provided with at least one processor 1001 and also includes a memory 1002, and they are connected through a data bus1003.

The memory is configured to store a computer program or instruction, and the processor is configured to obtain and execute the computer program or instruction, so that the electronic device performs the operation of FIG. 1, FIG. 2, FIG. 7 or FIG. 8.

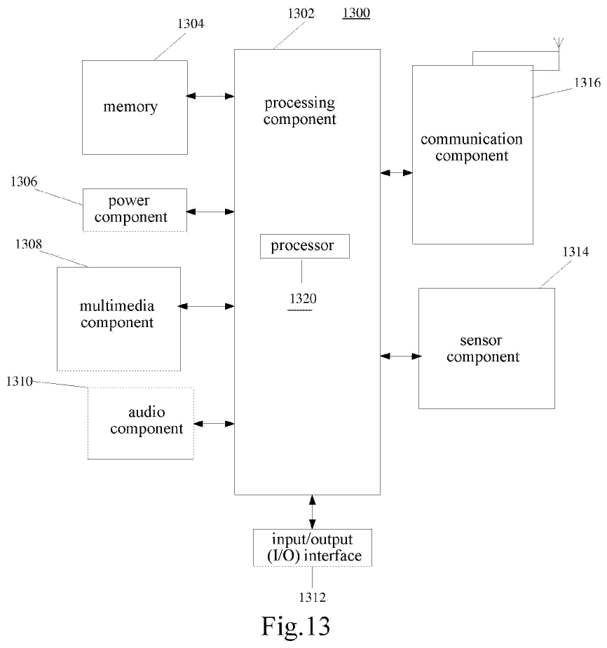

FIG. 13 is a structural block diagram showing another electronic device according to an example implementation. For example, the device 1300 may be a mobile phone, a computer, a digital broadcasting terminal, a messaging device, a game console, a tablet device, a medical device, a fitness device, a personal digital assistant, etc.

Referring to FIG. 13, the device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls the overall operations of the device 1300, such as the operations associated with display, telephone calls, data communications, camera operations, and recording operations. The processing component 1302 can include one or more processors 1320 to execute instructions to perform all or part of the operations in the above described methods. Moreover, the processing component 1302 can include one or more modules to facilitate the interaction between the processing component 1302 and other components. For example, the processing component 1302 can include a multimedia module to facilitate the interaction between the multimedia component 1308 and the processing component 1302.

The memory 1304 is configured to store various types of data to support the operation of the device 1300. Examples of such data include instructions for any application or method operated on device 1300, such as the contact data, the phone book data, messages, pictures, videos, and the like. The memory 1304 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the device 1300. The power component 1306 can include a power management system, one or more power sources, and other components associated with the generation, management, and distribution of power in the device 1300.

The multimedia component 1308 includes a screen providing an output interface between the device 1300 and the user. In some implementations, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some implementations, the multimedia component 1308 includes a front camera and/or a rear camera. When the device 1300 is in an operation mode, such as a photographing mode or a video mode, the front camera and/or the rear camera can receive external multimedia data. Each of the front camera and the rear camera may be a fixed optical lens system or have focus and optical zoom capability.

The audio component 1310 is configured to output and/or input an audio signal. For example, the audio component 1310 includes a microphone (MIC) configured to receive an external audio signal when the device 1300 is in an operation mode, such as a call mode, a recording mode, and a voice recognition mode. The received audio signal may be further stored in the memory 1304 or sent via the communication component 1316. In some implementations, the audio component 1310 also includes a speaker for outputting the audio signal.

The I/O interface 1312 provides an interface between the processing component 1302 and peripheral interface modules, such as a keyboard, a click wheel, a button, and the like. These buttons may include, but are not limited to, a home button, a volume button, a starting button, and a locking button.

The sensor component 1314 includes one or more sensors for providing state assessments of various aspects of the device 1300. For example, the sensor component 1314 can detect an open/closed state of the device 1300, relative positioning of components, such as the display and the keypad of the device 1300. The sensor component 1314 can also detect a change in position of one component of the device 1300 or the device 1300, the presence or absence of user contact with the device 1300, an orientation, or an acceleration/deceleration of the device 1300, and a change in temperature of the device 1300. The sensor component 1314 can include a proximity sensor configured to detect the presence of nearby objects without any physical contact. The sensor component 1314 can also include a light sensor, such as a CMOS or CCD image sensor, configured to use in imaging applications. In some implementations, the sensor component 1314 can also include an accelerometer sensor, a gyroscope sensor, a magnetic sensor, a pressure sensor, or a temperature sensor.

The communication component 1316 is configured to facilitate wired or wireless communication between the device 1300 and other devices. The device 1300 can access a wireless network based on a communication standard, such as WiFi, an operator network (such as 2G, 3G, 4G or 5G) or a combination thereof. In an example implementation, the communication component 1316 receives broadcast signals or broadcast associated information from an external broadcast management system via a broadcast channel. In an example implementation, the communication component 1316 also includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In an example implementation, the device 1300 may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, and used to perform the operations described in FIG. 1, FIG. 2, FIG. 5, FIG. 7 or FIG. 8.

In an example implementation, there is also provided a non-transitory computer-readable storage medium including instructions, such as a memory 1304 including instructions executable by the processor 1320 of the device 1300 to perform the above described method. For example, the non-transitory computer readable storage medium may be a ROM, a random access memory (RAM), a CD-ROM, a magnetic tape, a floppy disc, and an optical data storage device or the like.

1. An interactive method of real-time voice information, applied to an electronic device, and comprising:
obtaining voice data by recording and converting an input voice in response to a recording request, wherein the at least one piece of voice data is stored in a sending queue in a queue form;
sending the voice data in the sending queue to a server sequentially, wherein the sever is long connected with the electronic device; and
displaying the voice data in the sending queue locally in a list form, and displaying a sending state of the voice data.

2. The interactive method according to claim 1, wherein said obtaining voice data comprises:
generating an audio data at preset duration in response to recording the voice; and
collecting multiple pieces of audio data generated during a lifetime of the recording request into the voice data.

3. The interactive method according to claim 2, wherein said obtaining voice data further comprises:
controlling a video played by a real-time information interactive system locally to be mute in response to recording the voice.

4. The interactive method according to claim 1, wherein the sending state of the voice data comprises a sending ongoing state or a sending completed state.

5. The interactive method according to claim 1, further comprising:
in response to a deleting request, deleting voice data to which the deleting request is directed.

6. The interactive method according to claim 1, further comprising:
receiving audio video data pushed by the server, wherein the audio video data comprises audio data and video data recorded by the electronic device long connected with the server, and further comprises voice data recorded by a second electronic device that is at an equal position with the electronic device; and
playing the audio video data locally,
wherein a voice data displayed locally in the list form comprises the voice data recorded by the second electronic device.

7. The interactive method according to claim 6, further comprising:
detecting an ID of the audio video data being played; and
displaying a state of the voice data corresponding to the ID as a playing state in response to the ID of the audio video data being played corresponding to the voice data displayed in the list form.

8. The interactive method according to claim 7, further comprising:
controlling the voice data corresponding to the ID to play again or loop playback in response to a loop playback instruction.

9-20. (canceled)

21. A real-time voice information interactive method, applied to an electronic device, and comprising:
receiving a voice message sent by a server that is long connected with the electronic device;
displaying at least one piece of voice message received from the server in a list form; and
downloading and playing voice data corresponding to a selected voice message from the server in response to a downloading request.

22. The interactive method according to claim 21, further comprising:
adding an audio signal for playing the voice data to an audio stream collected locally in response to the voice data being played; and
pushing the audio stream, an ID of the voice data, and video stream collected locally to the server.

23. The interactive method according to claim 22, further comprising:
displaying a playing state of the voice message in a local list in response to the voice data being played.

24. The interactive method according to claim 22, further comprising:
playing voice data corresponding to the selected playing request in response to a selected playing request.

25-28. (canceled)

29. An electronic device, comprising:
a memory for storing instructions;
one or more a processors, coupled to the memory, wherein the one or more processors are configured to execute instructions causing the one or more processors to:
obtain at least one piece of voice data by recording and converting an input voice in response to a recording request, wherein the at least one piece of voice data is stored in a sending queue in a queue form;
send the voice data in the sending queue to a server sequentially, wherein the sever is long connected with the electronic device; and
display the voice data in the sending queue locally in a list form, and display a sending state of the voice data.

30. The electronic device according to claim 29, wherein the instructions further comprise instructions causing the one or more processors to generate an audio data at preset duration in response to recording the voice; and collect multiple pieces of audio data generated during a lifetime of the recording request into the voice data.

31. The electronic device according to claim 30, wherein the instructions further comprise instructions causing the one or more processors to control a video played by a real-time information interactive system locally to be mute during recording of the voice.

32. The interactive method according to claim 29, wherein the sending state of the voice data comprises a sending ongoing state or a sending completed state.

33. The electronic device according to claim 29, wherein the instructions further comprise instructions causing the one or more processors to, in response to a deleting request, delete voice data to which the deleting request is directed.

34. The electronic device according to claim 29, wherein the instructions further comprise instructions causing the one or more processors to receive audio video data pushed by the server, the audio video data comprises audio data and video data recorded by the electronic device long connected with the server, and further comprises voice data recorded by a second electronic device that is at an equal position with the electronic device; and play the audio video data locally, wherein a voice data displayed locally in the list form comprises the voice data recorded by the second electronic device.

35. The electronic device according to claim 34, wherein the instructions further comprise instructions causing the one or more processors to detect an ID of the audio video data being played; and display a state of the voice data corresponding to the ID as a playing state in response to the ID of the audio-video data being played corresponding to the voice data displayed in the list form.

36. The electronic device according to claim 35, wherein the instructions further comprise instructions causing the one or more processors to, in response to a loop playback instruction, control the voice data corresponding to the ID to play again or loop playback.

37. (canceled)

38. (canceled)

39. An electronic device, comprising:
a memory for storing instructions;
one or more processors coupled to the memory, wherein the one or more processors are configured to execute instructions causing the one or more processors to:
receive a voice message sent by a server that is long connected with the electronic device;
display at least one piece of voice message received from the server in a list form; and
download and play voice data corresponding to a selected voice message from the server in response to a downloading request.

40. The electronic device according to claim 39, wherein the instructions further comprise instructions causing the one or more processors to, in response to the voice data being played, add an audio signal for playing the voice data to an audio stream collected locally; and push the audio stream, an ID of the voice data, and video stream collected locally to the server.

41. The electronic device according to claim 40, wherein the instructions further comprise instructions causing the one or more processors to, in response to the voice data being played, display a playing state of the voice message in a local list.

42. The electronic device according to claim 40, wherein the instructions further comprise instructions causing the one or more processors to, in response to a selected playing request, play voice data corresponding to the selected playing request.

43-45. (canceled)
